(19) United States
(12) Patent Application Publication
(10) Pub. No.: US 2025/0299187 A1
(43) Pub. Date: Sep. 25, 2025

(54) TRANSACTION PROCESSING APPARATUS AND TRANSACTION PROCESSING METHOD

(71) Applicant: TOSHIBA TEC KABUSHIKI KAISHA, Tokyo (JP)

(72) Inventor: Ken Aoki, Mishima Shizuoka (JP)

(21) Appl. No.: 18/979,698

(22) Filed: Dec. 13, 2024

(30) Foreign Application Priority Data
Mar. 25, 2024 (JP) 2024-048299

(51) Int. Cl. G06Q 20/38; G06Q 30/0207

(52) U.S. Cl. CPC G06Q 20/387; G06Q 30/0222

(57) ABSTRACT

According to one embodiment, a transaction processing apparatus includes a determination unit and an application unit. The determination 1 unit determines whether a transaction satisfies an amount condition based on an amount of the transaction. The application unit applies a coupon identified by input coupon information to the transaction if the transaction satisfies the amount condition.

### CROSS-REFERENCE TO RELATED APPLICATION

This application is based upon and claims the benefit of priority from Japanese Patent Application No. 2024-048299, filed on Mar. 25, 2024, the entire contents of which are incorporated herein by reference.

### FIELD

Embodiments described herein relate generally to a transaction processing apparatus and a transaction processing method.

### BACKGROUND

As a coupon applicable to a transaction, there is a discount coupon for subtraction from a subtotal amount. If a store clerk reads a code symbol of a discount coupon with a scanner, a POS (Point of sales) terminal applies the discount coupon to a transaction.

In a certain case, a store side wishes to set a condition on application of a discount coupon to a transaction. In this case, a store clerk should confirm that the condition is satisfied before reading a code symbol of the discount coupon with a scanner. Accordingly, a load on the store clerk is heavier.

### DESCRIPTION OF THE DRAWINGS

FIG. 1 is a block diagram for exemplification of a POS terminal according to an embodiment.

FIG. 2 is a flowchart showing an example of a procedure of transaction processing by a processing circuit of the POS terminal.

FIG. 3 is a flowchart showing an example of a procedure of coupon processing by the processing circuit.

### DETAILED DESCRIPTION

A challenge to be solved by the present disclosure is to provide a technique that enables checking as to whether a coupon is applicable to a transaction.

In general, according to one embodiment, a transaction processing apparatus includes determining means and applying means. The determining means determines whether a transaction satisfies an amount condition based on an amount of the transaction. The applying means applies a coupon identified by input coupon information to the transaction if the transaction satisfies the amount condition.

As below, several embodiments will be explained using the drawings. In the individual drawings used for explanation of the following embodiments, scales of individual parts may be appropriately changed. Further, in the individual drawings used for explanation of the following embodiments, configurations may be omitted for explanation.

### Embodiments

With a POS terminal as an example, a transaction processing apparatus processing a transaction is explained. The transaction is a payment of an expense from a customer to a store with selling of a merchandise item by the store. The transaction includes selling of a merchandise item in view of the store. The transaction includes a purchase of a merchandise item in view of the customer. The merchandise item includes not only goods but also an object such as a service or ticket different from a tangible object. The expression “transaction” refers to an identical single transaction unless otherwise noted. The customer includes a user.

A coupon is for providing a privilege to the customer. The privilege is an incentive provided to the customer in the transaction. The coupon may be a coupon issued by printing on a medium such as a paper or a coupon electronically issued. Hereinafter, the coupon issued by printing on a medium such as a paper is also referred to as “printed coupon”. The electrically issued coupon is also referred to as “electronic coupon”. The electronic coupon is a coupon that can be displayed as an image on a terminal of the customer. For example, the terminal includes, but is not limited to, a device having a display function such as a smartphone or tablet.

The coupon will be explained as a coupon for subtraction of a discount amount of the coupon from a subtotal amount immediately before the coupon is applied to the transaction. The discount amount of the coupon may be an amount set by the coupon or an amount according to a rate set by the coupon. The application of the coupon to the transaction includes updating of the subtotal amount by subtraction of the discount amount of the coupon from the subtotal amount immediately before the application of the coupon to the transaction. The updated subtotal amount is an amount obtained by subtraction of the discount amount of the coupon from the subtotal amount immediately before the application of the coupon to the transaction. Not only one coupon but also more coupons are applicable to the transaction. The application includes use.

The subtotal amount is an amount based on a combined amount of the transaction after registrations of all merchandise items to be transacted in the transaction are finished. The subtotal amount may be an amount including consumption tax or an amount not including consumption tax. The combined amount is an amount based on a total of merchandise item prices of all registered merchandise items in the transaction. The registered merchandise item is a merchandise item registered as a merchandise item to be transacted payment of the transaction. The merchandise item price of the registered merchandise item may be an amount including consumption tax or an amount not including consumption tax. The combined amount may be an amount including consumption tax or an amount not including consumption tax. Note that, depending on a merchandise item, a discount may be set at the store. For example, a discount amount may be set at the store on a merchandise item such as prepared food according to the time of day. Accordingly, the combined amount may refer to an amount obtained by subtraction of a discount amount set at the store from the total of the merchandise item prices of all registered merchandise items in the transaction.

The subtotal amount differs depending on whether the coupon is already applied to the transaction. If the coupon is not yet applied to the transaction, the subtotal amount is the combined amount. If one or more coupons are already applied to the transaction, the subtotal amount is an amount determined by subtraction of a discount amount of the one or more coupons from the combined amount. The subtotal amount is an example of a transaction amount as an amount relating to the transaction. Note that another coupon than the coupon for subtraction of the discount amount of the coupon from the subtotal amount may be applied to the transaction. For example, if a coupon for discount of a designated merchandise item is already applied to the transaction, the subtotal amount is an amount on which the discount amount of the coupon is reflected.

### Configuration Example

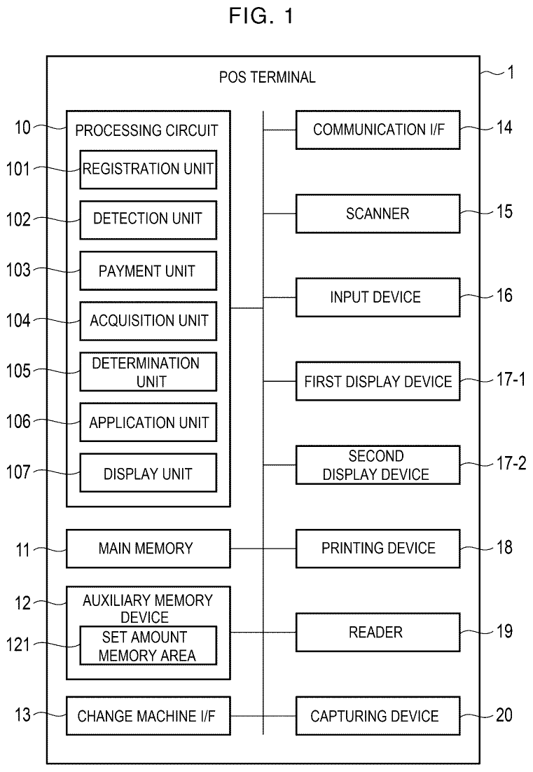

FIG. 1 is a block diagram for exemplification of a POS terminal 1.

The POS terminal 1 is an apparatus processing a transaction in a store. The POS terminal 1 is an example of a transaction processing apparatus processing a transaction.

The POS terminal 1 includes a processing circuit 10, a main memory 11, an auxiliary memory device 12, a change machine interface 13, a communication interface 14, a scanner 15, an input device 16, a first display device 17-1, a second display device 17-2, a printing device 18, a reader 19, and a capturing device 20. The processing circuit 10, the main memory 11, the auxiliary memory device 12, the change machine interface 13, the communication interface 14, the scanner 15, the input device 16, the first display device 17-1, the second display device 17-2, the printing device 18, the reader 19, and the capturing device 20 are connected to input and output signals to one another. In FIG. 1, the interface is shown by “I/F”.

The processing circuit 10 corresponds to a center part of the POS terminal 1. The processing circuit 10 is an element forming a computer of the POS terminal 1. The processing circuit 10 includes one or more circuits executing a plurality of pieces of processing by a plurality of functions. For example, the circuit includes, but is not limited to, a processor, an ASIC (Application Specific Integrated Circuit), or an FPGA (field-Programmable Gate Array). For example, the processor includes, but is not limited to, a CPU (Central Processing Unit) or a GPU (Graphics Processing Unit). The processing circuit 10 loads a program stored in the main memory 11 or the auxiliary memory device 12 in the main memory 11. The program is a program that enables the processing circuit 10 to execute various kinds of processing. The processing circuit 10 can execute various kinds of processing by executing the program loaded in the main memory 11.

The main memory 11 includes an element corresponding to a main memory part of the POS terminal 1. The main memory 11 is an element forming the computer of the POS terminal 1. The main memory 11 includes a non-volatile memory area and a volatile memory area. The main memory 11 stores an operating system or a program in the non-volatile memory area. The main memory 11 uses the volatile memory area as a work area in which data is appropriately rewritten by the processing circuit 10. For example, the main memory 11 includes a ROM (Read Only Memory) as the non-volatile memory area. For example, the main memory 11 includes a RAM (Random Access Memory) as the volatile memory area. The main memory 11 is an example of a memory unit.

The auxiliary memory device 12 corresponds to an auxiliary memory part of the POS terminal 1. The auxiliary memory device 12 includes one or more memory devices. The memory device includes, but is not limited to, an EEPROM (registered trademark) (Electric Erasable Programmable Read-Only Memory), an HDD (Hard Disc Drive), an SSD (Solid State Drive), or a flash memory. The auxiliary memory device 12 stores the program described above, data used by the processing circuit 10 for performing various kinds of processing and data generated by processing in the processing circuit 10. The auxiliary memory device 12 is an example of the memory unit.

The auxiliary memory device 12 includes a set amount memory area 121. The set amount memory area 121 stores a set amount. The set amount is a value used for determination as to whether the transaction satisfies an amount condition. The amount condition is a condition defined based on a subtotal amount, a discount amount of a coupon identified by a coupon code input to the POS terminal 1, and the set amount.

The coupon code is information by which the coupon can be uniquely identified. The coupon code is an example of coupon information by which the coupon can be uniquely identified. Hereinafter, the coupon code input to the POS terminal 1 is also referred to as “input coupon code”. The coupon identified by the input coupon code is also referred to as “input coupon”.

For example, the amount condition is a condition that an amount obtained by subtraction of a discount amount of the input coupon from the subtotal amount is higher than the set amount. The set amount can be appropriately set.

The change machine interface 13 inputs and outputs data signals between an automatic change machine and itself. For example, the change machine interface 13 receives inserted amount data from the automatic change machine. The change machine interface 13 outputs change amount data to the automatic change machine. The automatic change machine ejects bills or coins corresponding to the change amount according to the charge amount data.

The communication interface 14 includes various interfaces communicably connecting the POS terminal 1 to other devices via a network according to a predetermined communication protocol.

The scanner 15 is a device reading various code symbols. The scanner 15 is an example of a reading unit.

For example, the code symbol is a barcode symbol or a two-dimensional code symbol. The code symbol may be a code symbol of a merchandise item in which a merchandise item code is recorded. The merchandise item code is information by which a merchandise item can be uniquely identified. The code symbol of the merchandise item is an image attached to the merchandise item. The code symbol may be a code symbol of a member in which a member code is recorded. The member code is information by which a customer can be uniquely identified as a member. The code symbol of the member may be an image attached to a member card or an image that can be displayed on a terminal of the customer. The code symbol may be a code symbol of a coupon in which a coupon code is recorded. If the coupon is a printed coupon, the code symbol of the printed coupon is an image attached to the printed coupon. If the coupon is an electronic coupon, the code symbol of the electronic coupon is an image that can be displayed on the terminal of the customer. The code symbol may be a code symbol for code settlement.

The input device 16 is a device that can input information or an instruction to the POS terminal 1. For example, the input device 16 may include a keyboard. The input device 16 may form a touch screen with the first display device 17-1. The input device 16 is an example of an input unit.

The first display device 17-1 is a device that can display various images under control of the processing circuit 10. The first display device 17-1 is a display device for store clerk mainly for visual recognition by a store clerk. For example, the first display device 17-1 is a liquid crystal display, an EL (Electroluminescence) display, or the like. The first display device 17-1 is an example of a display unit.

The second display device 17-2 is a device that can display various images control of the processing circuit 10. The second display device 17-2 is a display device for customer mainly for visual recognition by a customer. For example, the second display device 17-2 is a liquid crystal display, an EL display, or the like. The second display device 17-2 is an example of the display unit.

The printing device 18 is a device for issuing a printed material by printing on a medium. For example, the medium is a paper. For example, the printing device 18 is a thermal printer, an inkjet printer, or the like. The printing device 18 is an example of a printing unit.

The reader 19 is a device reading card data recorded in a card medium. The reader 19 may include a contact reader reading card data recorded in a magnet stripe of a card medium. The reader 19 may include a contactless reader reading card data recorded in an IC (Integrated Circuit) tag of a card medium. The IC tag includes an IC chip and an antenna.

The capturing device 20 is a device that can capture an image under control of the processing circuit 10. For example, the capturing device 20 is a camera. The capturing device 20 is an example of a reading unit.

Note that the hardware configuration of the POS terminal 1 is not limited to the above described configuration. Appropriately, the above described component elements can be omitted and changed from or new component elements can be added to the POS terminal 1.

The individual units implemented by the processing circuit 10 are explained.

The processing circuit 10 implements a registration unit 101, a detection unit 102, a payment unit 103, an acquisition unit 104, a determination unit 105, an application unit 106, and a display unit 107. The units implemented by the processing circuit 10 may be also referred to as sections or functions. The individual units implemented by the processing circuit 10 may be implemented by a control unit including the processing circuit 10 and the main memory 11.

The registration unit 101 processes a registration of a merchandise item. The registration of a merchandise item is a registration of a merchandise item to be transacted before a payment of a transaction. Hereinafter, the registration of a merchandise item is also referred to as “merchandise item registration”.

The detection unit 102 detects information or an instruction input via the input device 16.

The payment unit 103 processes a payment of a transaction.

The acquisition unit 104 acquires an input coupon code.

The determination unit 105 determines whether an input coupon identified by an input coupon code is applied to a transaction.

The application unit 106 applies an input coupon to a transaction. The application unit 106 updates a subtotal amount at each time when an input coupon coupon is applied to a transaction.

The display unit 107 displays an image on at least one of the first display device 17-1 and the second display device 17-2.

### Operation Examples

The processing by the POS terminal 1 will be explained.

Note that the processing procedures to be described are just examples and the individual processing may be changed as far as possible. Further, appropriately, omission, replacement, and addition of steps can be made to the processing procedures to be described according to the embodiment.

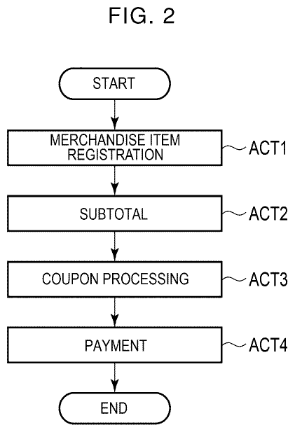

FIG. 2 is a flowchart showing an example of a procedure of transaction processing by the processing circuit 10 of the POS terminal 1.

The transaction processing is processing for closing one transaction. Here, a store clerk performs operations for a merchandise item registration and a payment using the POS terminal 1.

The processing circuit 10 processes a merchandise item registration (ACT 1). ACT 1 may be processing by the registration unit 101. In ACT 1, for example, the processing circuit 10 acquires a merchandise item code of a merchandise item to be transacted based on reading of a code symbol of the merchandise item to be transacted by the scanner 15. The processing circuit 10 may acquire a merchandise item code of the merchandise item to be transacted based on reading of a code symbol of the merchandise item to be transacted by the capturing device 20. The processing circuit 10 may acquire a merchandise item code of the merchandise item to be transacted based on selection of the merchandise item to be transacted using the input device 16. The processing circuit 10 processes a merchandise item registration based on the acquired merchandise item code.

For example, to process a merchandise item registration is to update registration data. The registration data may include information of a registered merchandise item with respect to each registered merchandise item. The information of a registered merchandise item may include all or part of a merchandise item code, a merchandise item name, a price, a quantity, and a merchandise item amount. The merchandise item code is as described above. The merchandise item name is a name of a merchandise item. The price is a unit price for one merchandise item. The quantity is the number of merchandise items identified by a merchandise item code. The merchandise item amount is an amount obtained by multiplication of the price and the quantity. The information of a registered merchandise item may include other information than that.

The registration data may be stored in the main memory 11 or the auxiliary memory device 12 of the POS terminal 1, or stored in a transaction management server that manages the individual transactions. To update the registration data includes to add information of a registered merchandise item, to increase the quantity contained in the information of the registered merchandise item, to reduce the quantity contained in the information of the registered merchandise item, and to delete the information of the registered merchandise item.

If the registration data is stored in the POS terminal 1, the processing circuit 10 updates the registration data based on the acquired merchandise item code with reference to merchandise item master data. The merchandise item master data includes merchandise item information with respect to each merchandise item available in a store. The merchandise item information may include a merchandise item code, a merchandise item name, and a price. The merchandise item information may include other information than that. If the registration data is stored in the transaction management server, the processing circuit 10 outputs a registration request containing a merchandise item code to the transaction management server. The registration request is a request for the transaction management server to process a merchandise item registration. The transaction management server may update registration data based on the merchandise item code contained in the registration request with reference to the merchandise item master data. To output the registration request containing the merchandise item code to the transaction management server is an example of to process a merchandise item registration.

The processing circuit 10 detects a payment instruction input via the input device 16 based on an operation of a subtotal button (ACT 2). ACT 2 may be processing by the detection unit 102. The payment instruction is an instruction for the POS terminal 1 to obtain a subtotal amount for a payment after registrations of all merchandise items to be transacted in the transaction are finished. The payment instruction is an instruction that can be input based on an operation of a subtotal button in the input device 16. The subtotal button is a button operated after the registrations of all merchandise items to be transacted in the transaction are finished. The store clerk operates the subtotal button using the input device 16 after the registrations of all merchandise items to be transacted in the transaction are finished by the POS terminal 1.

The processing circuit 10 executes coupon processing (ACT 3). The coupon processing is processing including processing of determining whether the input coupon is applied to the transaction for application of the input coupon to the transaction. The coupon processing is processing after the registrations of all merchandise items to be transacted in the transaction are finished by the POS terminal 1 and before a payment of the transaction. The coupon processing in ACT 3 will be described later.

The processing circuit 10 processes a payment of the transaction based on a payment amount (ACT 4). ACT 4 may be processing by the payment unit 103. The payment amount is an amount for closing the transaction. The payment amount corresponds to an amount to be paid by a customer. If the subtotal amount is an amount containing consumption tax, the payment amount corresponds to the subtotal amount. If the subtotal amount is an amount not containing consumption tax, the payment amount is an amount obtained by addition of consumption tax to the subtotal amount. The payment is a payment for the transaction. The payment includes a settlement. The completion of the payment by the POS terminal 1 includes closing of the transaction.

A payment method for a payment of the transaction includes an offline settlement and an online settlement. The offline settlement is a payment for which the POS terminal 1 does not require cooperation with another apparatus via a network. For example, the offline settlement is a payment with cash, a gift certificate, or the like. The online settlement is a payment for which the POS terminal 1 requires cooperation with another apparatus via a network. For example, the online settlement is a credit card settlement, an electronic money settlement, a debit card settlement, a code settlement, or the like.

The coupon processing in ACT 3 is explained.

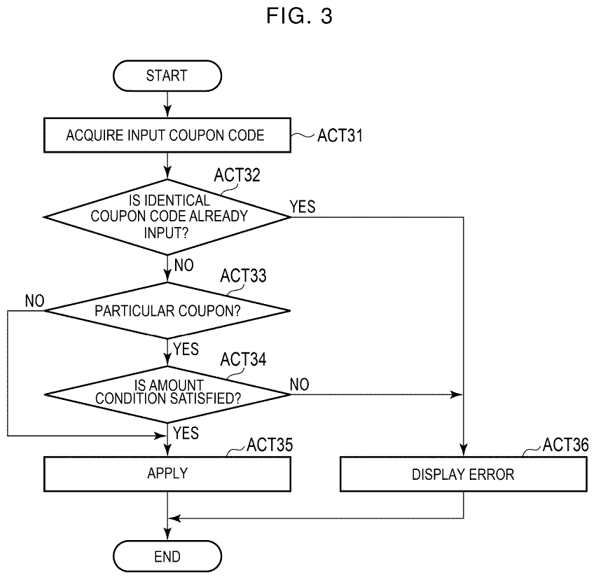

FIG. 3 is a flowchart showing an example of a procedure of coupon processing by the processing circuit 10 of the POS terminal 1.

The processing circuit 10 executes coupon processing with respect to each input coupon code. Here, if the customer wishes to apply a coupon to the transaction, the customer presents the coupon to the store clerk. The store clerk reads a code symbol of the coupon using the scanner 15 or the capturing device 20. The code symbol of the coupon may be a code symbol of a printed coupon or a code symbol of an electronic coupon.

The processing circuit 10 acquires the input coupon code (ACT 31). ACT 31 may be processing by the acquisition unit 104. In ACT 31, for example, the processing circuit 10 may acquire the input coupon code input to the POS terminal 1 based on reading of the code symbol of the coupon by the scanner 15. The processing circuit 10 acquires the input coupon code input to the POS terminal 1 based on reading of the code symbol of the coupon by the capturing device 20.

The processing circuit 10 determines, before input of the input coupon code to the POS terminal 1, whether an identical coupon code is already input to the POS terminal 1 in the transaction based on the input coupon code (ACT 32). ACT 32 may be processing by the determination unit 105. The identical coupon code refers to another input coupon code by which an identical coupon to the input coupon can be identified. The description “before input of the input coupon code to the POS terminal 1” may be read as “before acquisition of the input coupon code”. The description “before input of the input coupon code to the POS terminal 1” may be read as “before determination as to whether the input coupon code is applied to the transaction”. The description “an identical coupon code is already input to the POS terminal 1 in the transaction” may be read as “whether another input coupon code identified by the identical coupon code is applied to the transaction is already determined”.

In ACT 32, for example, the processing circuit 10 stores a list of input coupon codes already input in the transaction in the main memory 11 or the auxiliary memory device 12. The processing circuit 10 may determine whether the identical coupon code is already input to the POS terminal 1 in the transaction before input of the input coupon code to the POS terminal 1, with reference to the list of the input coupon codes. If the list contains the acquired input coupon code, the processing circuit 10 determines that the identical coupon code is already input to the POS terminal 1 in the transaction. If the list does not contain the acquired input coupon code, the processing circuit 10 determines that the identical coupon code is not yet input to the POS terminal 1 in the transaction.

If the identical coupon code is already input to the POS terminal 1 in the transaction (ACT 32, YES), the processing circuit 10 determines that the input coupon identified by the input coupon code is not applied to the transaction. In this case, the processing shifts from ACT 32 to ACT 36. For example, if the customer presents a plurality of the same coupons to the store clerk in the same transaction, the processing circuit 10 determines that the identical coupon code is already input to the POS terminal 1 in the transaction.

If the identical coupon code is not yet input to the POS terminal 1 in the transaction (ACT 32, NO), the processing shifts from ACT 32 to ACT 33. For example, if the customer presents a coupon not yet presented to the store clerk in the transaction, the processing circuit 10 determines that the identical coupon code is not yet input to the POS terminal 1 in the transaction.

As described above, the POS terminal 1 may determine, before input of the input coupon code to the POS terminal 1, whether an identical coupon code is already input to the POS terminal 1 in the transaction. If the identical coupon code is already input to the POS terminal 1 in the transaction, the POS terminal 1 may determine that the input coupon is not applied to the transaction.

If the store side wishes to limit the number of identical coupons that can be used for the transaction, the POS terminal 1 may check whether the identical coupon code is already input to the POS terminal 1 in the transaction. It is not necessary for the store clerk to do work to confirm usage of a plurality of identical coupons in the transaction, and the load on the store clerk is reduced.

The processing circuit 10 determines whether the input coupon is a particular coupon (ACT 33). ACT 33 may be processing by the determination unit 105. The particular coupon is a coupon for adding an amount condition to the application of the coupon to the transaction. For example, the particular coupon includes, but is not limited to, an electronic coupon. Here, the store clerk is able to collect the printed coupon applied to the transaction, however, not able to collect the electronic coupon applied to the transaction. The customer can use the electronic coupon as many times as desired with respect to each transaction. Accordingly, it is preferable to add an amount condition to the application of the coupon to the transaction.

In ACT 33, for example, the processing circuit 10 determines whether the input coupon code contains a code indicating a particular coupon. If the input coupon code contains a code indicating a particular coupon, the processing circuit 10 determines that the input coupon is the particular coupon. If the input coupon code does not contain a code indicating a particular coupon, the processing circuit 10 determines that the input coupon is a coupon different from the particular coupon.

If the input coupon is the particular coupon (ACT 33, YES), the processing shifts from ACT 33 to ACT 34. If the input coupon is a coupon different from the particular coupon (ACT 32, NO), the processing circuit 10 determines that the input coupon identified by the input coupon code is applied to the transaction. In this case, the processing shifts from ACT 33 to ACT 35.

As described above, the POS terminal 1 may determine whether the input coupon is the particular coupon.

If the store side wishes to add an amount condition to the application of the particular coupon to the transaction, the POS terminal 1 may check whether the input coupon is the particular coupon. It is not necessary for the store clerk to do work to confirm whether the presented coupon is the particular coupon, and the load on the store clerk is reduced.

The processing circuit 10 determines whether the transaction satisfies the amount condition based on the subtotal amount (ACT 34). ACT 34 may be processing by the determination unit 105. The subtotal amount used for the determination as to whether the transaction satisfies the amount condition is a current subtotal amount. The current subtotal amount includes a subtotal amount at a time when the coupon code is input as the input coupon code to the POS terminal 1. The current subtotal amount includes a subtotal amount at a time when the input coupon code is acquired by the processing circuit 10.

The processing circuit 10 specifies a discount amount of the input coupon based on a code contained in the input coupon code. If an amount obtained by subtraction of the discount amount of the input coupon from the subtotal amount is higher than the set amount, the processing circuit 10 determines that the transaction satisfies the amount condition. If an amount obtained by subtraction of the discount amount of the input coupon from the subtotal amount is not higher than the set amount, the processing circuit 10 determines that the transaction does not satisfy the amount condition. Thereby, the POS terminal 1 may prevent the subtotal amount from being the set amount or less by application of the input coupon to the transaction.

If the transaction satisfies the amount condition (ACT 34, YES), the processing circuit 10 determines that the input coupon is applied to the transaction. In this case, the processing shifts from ACT 34 to ACT 35. If the transaction does not satisfy the amount condition (ACT 34, NO), the processing circuit 10 determines that the input coupon is not applied to the transaction. The processing shifts from ACT 34 to ACT 36.

As described above, the POS terminal 1 may determine whether the transaction satisfies the amount condition.

If the store side wishes to add an amount condition to the application of the coupon to the transaction, the POS terminal 1 may check whether the transaction satisfies the amount condition. It is not necessary for the store clerk to do work to confirm whether the transaction satisfies the amount condition at each time when the coupon is presented, and the load on the store clerk is reduced.

The processing circuit 10 applies the input coupon to the transaction (ACT 35). ACT 35 may be processing by the application unit 106. In ACT 35, for example, the processing circuit 10 updates the subtotal amount by subtraction of the discount amount of the input coupon from the subtotal amount immediately before the application of the input coupon to the transaction. The subtotal amount immediately before the application of the input coupon to the transaction corresponds to the above described current subtotal amount. If the input coupon is a coupon different from the particular coupon, the processing circuit 10 applies the input coupon to the transaction.

In the above described manner, the POS terminal 1 may apply the input coupon to the transaction without executing a determination as to whether the transaction satisfies the amount condition. Accordingly, even if the transaction does not satisfy the amount condition, the input coupon is applied to the transaction.

If the transaction satisfies the amount condition, the processing circuit 10 may apply the input coupon to the transaction. In a typical example, if the input coupon is the particular coupon and the transaction satisfies the amount condition, the processing circuit 10 may apply the input coupon to the transaction.

In the above described manner, if the input coupon is the particular coupon, the POS terminal 1 may check whether the coupon is applicable to the transaction based on the amount condition. It is not necessary for the store clerk to do work to confirm whether the presented coupon is the particular coupon and confirm whether the coupon is applicable to the transaction based on the amount condition, and the load on the store clerk is reduced.

The processing circuit 10 displays an error image on at least one of the first display device 17-1 and the second display device 17-2 (ACT 36). ACT 36 may be processing by the display unit 107. The error image is an image relating to a failure to apply the input coupon to the transaction. The error image may contain a reason for a failure to apply the input coupon according to the determination result of the processing circuit 10.

The coupon processing is not limited to that described above.

The processing circuit 10 may omit the processing in ACT 32. In this example, the customer may use a plurality of identical coupons in the transaction.

The processing circuit 10 may execute the processing if the input coupon is the particular coupon, not before the processing in ACT 33. In this example, with respect to a coupon different from the particular coupon, the customer may use a plurality of identical coupons in the transaction.

The processing circuit 10 may omit the processing in ACT 33. In this example, regardless of the type of the input coupon, for the input coupon, the amount condition is added to the application of the input coupon to the transaction.

Specific examples will be explained.

It is assumed that merchandise items to be transacted in the transaction of the customer are a merchandise item A and a merchandise item B. A merchandise item amount of the merchandise item A is 200 yen. A merchandise item amount of the merchandise item B is 300 yen. At the time, a subtotal amount is 500 yen as a combined amount. A set amount is 200 yen. The customer presents three coupons to the store clerk in the following manner.

First, the customer presents an electronic coupon for a discount amount of 200 yen to the store clerk. The electronic coupon is a particular coupon. An amount (300 yen) obtained by subtraction of the discount amount (200 yen) of the electronic coupon from the current subtotal amount (500 yen) is higher than the set amount (200 yen). Accordingly, the processing circuit 10 determines that the transaction satisfies the amount condition and applies the electronic coupon to the transaction. The processing circuit 10 updates the subtotal amount to 300 yen by subtraction of the discount amount (200 yen) of the electronic coupon from the subtotal amount (500 yen) immediately before the application of the electronic coupon to the transaction. At the time, the subtotal amount is 300 yen.

Then, the customer presents an electronic coupon for a discount amount of 150 yen to the store clerk. The electronic coupon is a particular coupon. An amount (150 yen) obtained by subtraction of the discount amount (150 yen) of the electronic coupon from the current subtotal amount (300 yen) is not higher than the set amount (200 yen). Accordingly, the processing circuit 10 determines that the transaction does not satisfy the amount condition and does not apply the electronic coupon to the transaction. At the time, the subtotal amount is 300 yen.

Finally, the customer presents a printed coupon for a discount amount of 200 yen to the store clerk. The printed coupon is a coupon different from a particular coupon. An amount condition is not added to the application of the printed coupon to the transaction. Accordingly, the processing circuit 10 applies the printed coupon to the transaction. The processing circuit 10 updates the subtotal amount to 100 yen by subtraction of the discount amount (200 yen) of the printed coupon from the subtotal amount (300 yen) immediately before the application of the printed coupon to the transaction. At the time, the subtotal amount is 100 yen.

As described above, if the transaction satisfies the amount condition, the POS terminal 1 may apply the input coupon to the transaction.

If the store side wishes to add an amount condition to the application of the coupon to the transaction, the POS terminal 1 may check whether the input coupon is applicable to the transaction based on the amount condition. It is not necessary for the store clerk to do work to confirm whether the coupon is applicable to the transaction based on the amount condition, and the load on the store clerk is reduced.

### Other Embodiments

In the above description, the amount condition is defined based on the subtotal amount, the discount amount of the input coupon, and the set amount, however, not limited to that. The amount condition may be a condition defined based on the subtotal amount and the set amount. In this example, the amount condition may be a condition that the subtotal amount is higher than the set amount.

In the above description, the subtotal amount used for the determination as to whether the transaction satisfies the amount condition is the current subtotal amount, however, not limited that. The subtotal amount used for the determination as to whether the transaction satisfies the amount condition may be a combined amount as the subtotal amount without the application of the coupon to the transaction regardless of whether the coupon is already applied to the transaction.

In the above description, the POS terminal 1 having the merchandise item registration function and the payment function for which the store clerk intervenes between the merchandise item registration and the payment is taken as an example of the transaction processing apparatus, however, the apparatus is not limited to that. The transaction processing apparatus may be a POS terminal having a merchandise item registration function and a payment completion function by which the customer can make a merchandise item registration and a payment without store clerk intervention. The transaction processing apparatus may be a merchandise item registration apparatus having at least a merchandise item registration function. The transaction processing apparatus may be a payment apparatus having at least a payment function. The transaction processing apparatus may be a terminal having at least a merchandise item registration function and available to the customer in shopping. The terminal may be a dedicated terminal that can be mounted on a shopping cart, a portable terminal prepared in advance by the store or the like, or a portable terminal possessed by the customer.

All of the individual units implemented by the POS terminal 1 may be implemented by a server such as a transaction management server that can communicate with the POS terminal 1. In this case, the server is an example of the transaction processing apparatus. Part of the individual units implemented by the POS terminal 1 may be implemented by a server such as a transaction management server that can communicate with the POS terminal 1. In this case, the POS terminal 1 and the server are an example of the transaction processing apparatus.

The transaction processing apparatus may be implemented by a single apparatus as described above with the POS terminal 1 as an example or may be implemented by a plurality of apparatuses having distributed functions.

The above described embodiments may be applied to a method executed by the apparatus. The above described embodiments may be applied to a program that enables the computer of the apparatus to execute the individual functions. The above described embodiments may be applied to a storage medium storing a program.

Each of one or more circuits forming the processing circuit execute one or more pieces of processing of a plurality of pieces of processing. If the processing circuit is configured by a single circuit, the single circuit executes all of the plurality of pieces of processing. If the processing circuit is configured by a plurality of circuits, each of the plurality of circuits executes a part of the plurality of pieces of processing. A part of the plurality of pieces of processing may be one of the plurality of pieces of processing or two or more of the plurality of pieces of processing. If the processing circuit is configured by a plurality of circuits, the plurality of circuits may be provided in a single apparatus or distributed in a plurality of apparatuses.

The program may be stored in an apparatus according to the embodiment and transferred or not stored in an apparatus and transferred. In the latter case, the program may be transferred via a network or recorded in a recording medium and transferred. The recording medium is a non-transitory tangible medium. The recording medium is a computer-readable medium. The recording medium may have any form as long as the medium can store a program and can be read by a computer such as a CD-ROM or a memory card.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

The above described several embodiments may be expressed as follows.

(1) A transaction processing apparatus includes a determination unit determining whether a transaction satisfies an amount condition based on an amount of the transaction, and an application unit applying a coupon identified by input coupon information to the transaction if the transaction satisfies the amount condition.

(2) In the apparatus according to (1), the determination unit determines whether the coupon is a particular coupon, and the application unit applies the coupon to the transaction if the coupon is the particular coupon and the transaction satisfies the amount condition.

(3) In the apparatus according to (2), the application unit applies the coupon to the transaction if the coupon is another coupon than the particular coupon.

(4) In the apparatus according to (1), the amount condition includes a condition that an amount obtained by subtraction of a discount amount of the coupon from the amount of the transaction is higher than a set amount.

(5) In the apparatus according to (1), the particular coupon is an electronically issued coupon.

(6) A program enables a computer to execute a function of determining whether a transaction satisfies an amount condition based on an amount of the transaction, and a function of applying a coupon identified by input coupon information to the transaction if the transaction satisfies the amount condition.

What is claimed is:

1. A transaction processing apparatus, comprising:
a determining component configured to determine whether a transaction satisfies an amount condition based on an amount of the transaction; and
an applying component configured to apply a coupon identified by input coupon information to the transaction if the transaction satisfies the amount condition.

2. The transaction processing apparatus according to claim 1, wherein
the determining component determines whether the coupon is a particular coupon, and
the applying component applies the coupon to the transaction if the coupon is the particular coupon and the transaction satisfies the amount condition.

3. The transaction processing apparatus according to claim 2, wherein
the applying component applies the coupon to the transaction if the coupon is another coupon than the particular coupon.

4. The transaction processing apparatus according to claim 1, wherein
the amount condition includes a condition that an amount obtained by subtraction of a discount amount of the coupon from the amount of the transaction is higher than a set amount.

5. The transaction processing apparatus according to claim 2, wherein
the particular n is an electronically issued coupon.

6. The transaction processing apparatus according to claim 1, wherein
the coupon is one of a paper printed coupon or an electronic coupon.

7. The transaction processing apparatus according to claim 1, further comprising a scanner configured to read various code symbols, wherein the coupon comprises a code symbol.

8. A method for a computer to execute, comprising:
determining whether a transaction satisfies an amount condition based on an amount of the transaction; and
applying a coupon identified by input coupon information to the transaction if the transaction satisfies the amount condition.

9. The method according to claim 8, further comprising:
determining whether the coupon is a particular coupon, and
applying the coupon to the transaction if the coupon is the particular coupon and the transaction satisfies the amount condition.

10. The method according to claim 9, further comprising:
applying the coupon to the transaction if the coupon is another coupon than the particular coupon.

11. The method according to claim 8, wherein
the amount condition includes a condition that an amount obtained by subtraction of a discount amount of the coupon from the amount of the transaction is higher than a set amount.

12. The method according to claim 8, wherein
the coupon is one of a paper printed coupon or an electronic coupon.

13. The method according to claim 8, further comprising:
reading various code symbols, wherein the coupon comprises a code symbol.

14. A point of sales terminal, comprising:
a processor;
a memory;
a change machine interface;
a communication interface;
a determining component configured to determine whether a transaction satisfies an amount condition based on an amount of the transaction; and
an applying component configured to apply a coupon identified by input coupon information to the transaction if the transaction satisfies the amount condition.

15. The point of sales terminal according to claim 14, wherein
the determining component determines whether the coupon is a particular coupon, and
the applying component applies the coupon to the transaction if the coupon is the particular coupon and the transaction satisfies the amount condition.

16. The point of sales terminal according to claim 15, wherein
the applying component applies the coupon to the transaction if the coupon is another coupon than the particular coupon.

17. The point of sales terminal according to claim 14, wherein
the amount condition includes a condition that an amount obtained by subtraction of a discount amount of the coupon from the amount of the transaction is higher than a set amount.

18. The point of sales terminal according to claim 15, wherein
the particular coupon is an electronically issued coupon.

19. The point of sales terminal according to claim 14, wherein
the coupon is one of a paper printed coupon or an electronic coupon.

20. The point of sales terminal according to claim 14, further comprising a scanner configured to read various code symbols, wherein the coupon comprises a code symbol.
